(19) United States
(12) Patent Application Publication
(10) Pub. No.: US 2012/0023040 A1
(43) Pub. Date: Jan. 26, 2012

(54) METHOD AND SYSTEM FOR REAL-TIME EQUITY RISK PREMIUM

(75) Inventors: Bryan Benoit, Houston, TX (US); Taylor West, Alvin, TX (US)

(73) Assignee: Grant Thornton LLP, Chicago, IL (US)

(21) Appl. No.: 13/188,747

(22) Filed: Jul. 22, 2011

Related U.S. Application Data
(60) Provisional application No. 61/367,031, filed on Jul. 23, 2010.

(51) Int. Cl. G06Q 40/00

(52) U.S. Cl. 705/36 T; 705/36 R

(57) ABSTRACT

A process and integrated system for estimating a customized, ex-ante equity risk premium in real time or as of a user-specified historical date. A related database retrieves and processes selected market data and applies the method to determine the ex-ante ERP estimate. Modified versions of the method and system provide size risk premium estimates, industry risk premium estimates, and country risk premium estimates. Another embodiment recursively processes risk premium estimates to further improve accuracy.

### BACKGROUND OF THE INVENTION

1. Field of the Invention

The disclosed invention relates to a process and integrated system for estimating a customized, ex-ante equity risk premium, size risk premiums, industry risk premiums and country risk premiums in real time or as of a user-specified historical date.

2. Discussion of the Prior Art

The presently disclosed invention relates to risk premiums associated with securities which are commonly referred to as “equity risk premiums.” The equity risk premium (ERP) is the expected rate of return on stocks that is in excess of the risk-free rate. The expected return has economic and financial implications for corporations, governments and individuals because ERP estimates are used for allocating capital, pricing assets and determining sums that should be reserved to pay future obligations. The ERP is a key component in almost every method of deriving discount rates for asset pricing. Such methods include the capital asset pricing model (“CAPM”), the arbitrage pricing model, the multifactor model, the build-up method and others. These discount rates have a direct and significant effect on the valuation of specific assets and liabilities and thus also affect corporate investment decisions related to projects and acquisitions. For decades, academics and practitioners have debated the ERP, but no method has been universally accepted or used for deriving the ERP.

Estimates of expected returns drive investment decisions regarding how capital resources are allocated across geographies, industries, asset classes and specific investments. Such decisions are relevant to all investors: governments, private enterprises and individuals. Estimates of expected future returns also represent a critical assumption for governments, individuals and corporations when they are determining the amounts required to meet future obligations such as health care, retirement, asset decommissioning and debt payments, to name a few.

An accurate ERP estimate is both fundamental and essential in measuring economic value. In the past, there have been many attempts to accurately predict the ERP. These attempts typically fall into one of three groups:

1. Surveys—The reporting of ERP estimates based on surveys conducted by investors, academics and financial professionals.

2. Ex-post method—The derivation of ERP estimates based on historical returns of equity securities in excess of the risk-free rate.

3. Ex-ante method—The derivation of the ERP implied from current market prices and expected future benefits (e.g., dividends, stock appreciation).

ERP surveys are useful for gauging the general range of ERPs that are used by some groups. However, surveys lack direct, quantifiable linkage with the economy or the capital markets. Many qualitative issues exist with surveys, including how questions are presented, the profile of the respondents, and the timing of the survey. Studies have evidenced that surveys lack positive predictive power regarding future stock returns and in fact may have an inverse relationship with them.

As an alternative to surveys, prior art ERP estimates often have been based on the average historical return of equity securities in excess of the risk-free rate. Usually, the ERP is calculated on an annual basis over a long-temi historical period. This approach is commonly known as the ex-post method.

Many studies have concluded that the ex-post method is not a reliable indicator of the ERP. The ex-post method has been criticized because it relies on several assumptions. The most basic of those assumptions is that investors' expectations for future returns are the same as for historical returns. However, the ERP is intended to represent the returns that investors currently expect to achieve. Risk premiums change over time because the risk inherent in both the overall economy and the equity market changes, and investors demand different rates of return in exchange for assuming different levels of risk. Ex-post methods of estimating ERP generally have not considered prevailing equity market conditions at or near the relevant date. Ex-post returns provide only a historical data point that may or may not represent investors' expectations at the relevant date.

ERP is a forward-looking expectation of the risk premium as of the valuation date—a time for which no market quotes are available. ERPs that are calculated by reference to historical data over time can only be estimates of the expected ERP. To truly represent the ERP, there must be an estimate of the expected ERP as of the valuation date. That requires a projection beyond any already realized premiums.

Forward-looking ERP's have been determined by extrapolating the future returns expected by investors from observable market data. This practice is known as the ex-ante method. A number of ex-ante methods for estimating the ERP have been proposed in the prior art. However, none of those prior ex-ante processes or systems reliably determine an ex-ante ERP in real time or as of a specific date. The timeliest, currently available source is a monthly publication. As a result, practitioners generally estimate an ERP that is based on a qualitative assessment of dated results from ex-post and ex-ante ERP studies.

### Ex-Post Equity Risk Premiums

Precise econometric estimates of the equity premium were developed after the creation of the capital asset pricing model (“CAPM”)—a model that relies on the ERP as a central input. Since then, the ex-post ERP has been the most commonly cited ERP.

Until recently, the ex-post premium was considered to be the best available ERP estimate because of the weaknesses of surveys and the unavailability of information required to estimate an ex-ante ERP. Although ex-post premiums have been used for many years, they have inherent difficulties and shortcomings.

### Actual Versus Expected Returns

Ex-post ERPs are based on the premise that past performance is a valid proxy for expectations for future results. However, it has been found that realized returns are, at best, only a noisy proxy for expected stock returns. In fact, historical returns do not reflect investors' actual expectations making ex-post ERP estimates an inaccurate predictor of future returns. Several examples show that historical returns may not provide an accurate estimate of investors' expectations about future returns.

In the context of standard economics models, the high historical returns of equities compared to government bonds implies abnormally high risk aversion. There has been no commonly accepted explanation for the high return on equities relative to government bonds. It has become known as the equity risk premium puzzle. According to many economists, the equity risk premium puzzle is evidence that historical returns have been significantly higher than expected returns and, therefore, ex-post estimates do not reflect expected returns.

Based on considerations of equity fundamentals such as Sharpe ratios, book-to-market ratios, and income return on investment, the average stock return of the last half-century is much higher than expected. As a result, ex-post ERP measurements tend to overstate the premium that investors expected at that time.

The ex-post ERP—8.0 percent since 1926 and 6.5 percent since 1871—appears far in excess of that justified by standard asset-pricing models with reasonable levels of risk aversion, given the behavior of the variance-covariance matrix of historical returns on bonds, stocks and consumption.

A specific example in which observed returns did not align with the given risk of the investment is the McDonald's effect. Data sets within the second half of the 20th century pertaining to the fast-food chain McDonald's had abnormally large returns relative to risk. Investors were consistently surprised at the earnings reported by McDonald's, and those earnings resulted in stock price appreciation above the expected level of returns. McDonald's was a relatively new company when the earnings surprises were occurring, but there is evidence that mature companies can also have unusually large returns relative to risk. Such anomalies can also be observed in index returns, such as the 20 percent run-up of annual returns in the Japanese stock market from 1980 to 1990.

Ex-post ERP estimates assume that information surprises cancel out over the measurement period and that realized returns are therefore an unbiased estimate of expected returns. This assumption may be unwarranted. Time periods when both stock and bond risk and return do not follow an anticipated path include:
periods longer than 10 years in which realized stock market returns are on average less than the risk-free rate (1973-1984);
periods longer than 50 years in which high-risk long-term bonds on average underperform the risk-free rate (1927-1980); and
periods during which U.S. equity markets returned over 15%, while the Japanese market experienced a negative return (1990-1999).

### Time Period Sensitivity

Ex-post ERP measurements are sensitive to the time period over which the premium is calculated. Ex-post studies of historical returns on stocks and bonds have used periods as far back as the 1870s. Other studies examine returns beginning in 1926 or in the mid-1950s and the 1960s. Each time period yields significantly different ERP estimates. The current model for ex-post ERP assumes a constant variance rate. However, the large differences in variance rates over the various subperiods cause the model's estimates to be sensitive to the historical time period that is used.

There is disagreement over which time period is most appropriate for estimating current ERP. Some analysts advocate longer time periods because lower statistical noise is associated with longer-term estimates. Other analysts advocate shorter time periods because risk aversion has changed over time so that recent returns better reflect current investors' expectations. In fact, neither argument may be correct. The events and issues listed below are commonly cited as problems with certain historical time periods:

The concentration of railroad stocks prior to the 1860s

Regulatory changes in the NYSE in the 1860s

The unreliability of data prior to 1926

The bull market of the late 1920s followed by the 1929 stock market crash

The postwar economic boom in the 1930s and 1940s

The low interest rates from the 1930s through the 1950s

Dramatically rising interest rates since the 1950s

Significant changes in investment income tax structure since the 1950s

Recent decades' bond market volatility relative to more stable equity markets

The high standard errors indicated in 10-year and 20-year estimates

Obviously, each historical time period presents its own set of problems and results in a significantly different ex-post ERP.

### Statistical Reliability

As previously noted, empirical studies have concluded that historical returns are a noisy proxy for expected future returns. The statistical noise can be measured using the standard errors in ex-post estimates. The table below illustrates the standard errors in these estimates for various time periods ending in 2009 (Damodaran, 2010).

| Time period | Standard error (20% ÷ vn)* |
|---|---|
| 5 years | 8.94% |
| 10 years | 6.32% |
| 25 years | 4.00% |
| 50 years | 2.83% |
| 80 years | 2.23% |

*20% represents the standard deviation in stock prices between 1926 and 2008. The standard errors may be understated because they assume uncorrelated annual returns, while there is empirical evidence that the returns may be correlated over time.

As shown above, shorter time periods have extremely high standard errors. However, even the longer time periods have significant standard errors relative to the magnitude of the ERP itself.

### Survivorship Bias and Special Events

Historical stock market returns contain an upward survivorship bias that affects ex-post ERP estimates. The returns are measured by the performance of the S&P 500. Therefore, the focus is on surviving companies. The failure of many films is neglected. The survivorship bias is exacerbated by the focus on domestic U.S. markets, which represent the best-performing markets over the periods that are typically used for ex-post ERP estimates. The survivorship bias results in ERP estimates that exceed expected returns.

### Geometric Versus Arithmetic Mean

There is uncertainty over averaging historical data to calculate an ex-post ERP. Disagreement centers on whether to use a geometric mean or an arithmetic mean. The geometric mean represents the compound annual return over the estimation period, while the arithmetic mean measures the simple average of annual returns over that period.

Many contend that the geometric mean provides a better estimate of long-term returns, but others argue that the arithmetic mean provides a better estimate of the next period's returns. In practice, neither averaging technique is recognized as the preferred method. The table below shows that the two types of averaging result in extremely different ERP estimates.

| | ERP estimate | ERP estimate |
|---|---|---|
| Time period | (arithmetic average) | (geometric average) |
| 1928-2008 | 5.56% | 4.29% |
| 1967-2008 | 4.09% | 2.74% |
| 1997-2008 | 3.68% | 7.22% |

This is another dilemma where different options result in different ex-post ERP estimates.

### Volatility of Expected Returns

Substantial evidence shows that expectations for returns change over time. In general, expected returns are lower when economic conditions are strong and higher when conditions are weak, as determined based on a statistical analysis of default spreads and dividend yields by Fama and French (1989).

The hypothesis that the variance rate on the market remains constant over any appreciable period of time can be rejected at almost any confidence level. Different opinions explain the variation in expected returns. Some attribute it to rational variation in response to macroeconomic factors. Others assert that irrational swings in investor sentiment are the prime moving force.

Irrespective of the underlying reason for the variation in the ERP, the ex-post method cannot provide results reflecting expected returns, which are constantly changing. Long-term averages used in the ex-post method merely smooth the variation in expected returns and conceal the true ERP.

### Ex-Ante Equity Risk Premiums

The problems with ex-post ERP estimates are well-documented in economic and financial literature. Ex-ante ERP estimates avoid those problems, while providing a more theoretically sound and measurable estimate of returns expected by investors at the relevant date.

There is empirical evidence that ex-ante ERP estimates are more accurate than ex-post estimates based on standard errors, ratio analyses and valuation theory. However, most practitioners use realized returns as a proxy for expected returns because of the lack of data required to determine an ex-ante ERP. Fortunately, the amount of relevant data has increased significantly over time, and research within the past several years has yielded substantial progress in developing ex-ante ERP estimates.

Ex-ante ERP estimates are derived by populating generally accepted financial and economic models such as the CAPM, utility functions and the arbitrage pricing theory (APT) with observable market data and then solving for the ERP as the remaining unknown variable. In this way, economic factors such as trading prices, dividend yields, forward-looking analyst estimates, volatility and default spreads are used to derive market evidence of investors' expected returns.

The real-time equity risk premium (“RTERP”) disclosed herein is a process for estimating a customized ex-ante ERP in real time or as of a user-specified historical date. The RTERP is an integrated, software-based model with a related database that retrieves and processes selected market data from third-party data services. The process determines the ex-ante ERP estimate. The RTERP also provides size, industry, and country risk premium estimates, along with descriptive information such as statistics, graphs and charts.

The presently disclosed invention concerns a process and system for determining an ex-ante equity risk premium in real time or as of a specified date.

### SUMMARY OF THE INVENTION

The presently disclosed invention relates to risk premiums associated with securities. Risk premiums change over time as 1) the risk inherent in both the overall economy and the equity market changes, and 2) investors respond to equity market conditions by requiring different rates of return in exchange for taking risks. The presently disclosed invention concerns a process and system for determining an ex-ante equity risk premium in real time or as of a specified date.

In accordance with the disclosed invention, a method and computer system determine a long-term expected rate of return for each constituent of a selected market index. The long-term expected rate of return for each constituent is determined from a discount rate that equates the then-current value of future cash flow with the stock price of the constituent. A market capitalization-weighted average of the discount rates of the market index constituent is then calculated. The risk-free rate is then subtracted to determine an implied equity risk premium.

Preferably, the long-term expected rate of return for each market index constituent is determined from the internal rate of return of each constituent which causes the present value of future cash flow to equal the stock price of the constituent.

Other features, advantages and objects of the presently disclosed invention will become apparent to those skilled in the art as a description of a presently preferred embodiment thereof proceeds.

### BRIEF DESCRIPTION OF THE DRAWINGS

Several presently preferred embodiments of the disclosed invention are described in connection with the accompanying drawings in which:

FIG. 1 is a conceptual illustration of the method and system for determining ex-ante equity risk premiums herein disclosed.

FIG. 2 is a logic diagram that illustrates data flow in the method and system herein disclosed.

FIG. 3 is a logic diagram that illustrates data flow in the method and system herein disclosed.

FIG. 4 is a logic diagram that illustrates data flow in an alternative embodiment of the method and system herein disclosed.

FIG. 5 is a logic diagram that illustrates data flow in a second alternative embodiment of the method and system herein disclosed.

FIG. 6 is a logic diagram that illustrates data flow in a third alternative embodiment of the method and system herein disclosed.

FIG. 7 illustrates a recursive process for improving the accuracy of ex-ante risk premium estimates.

### DESCRIPTION OF PRESENTLY PREFERRED EMBODIMENTS

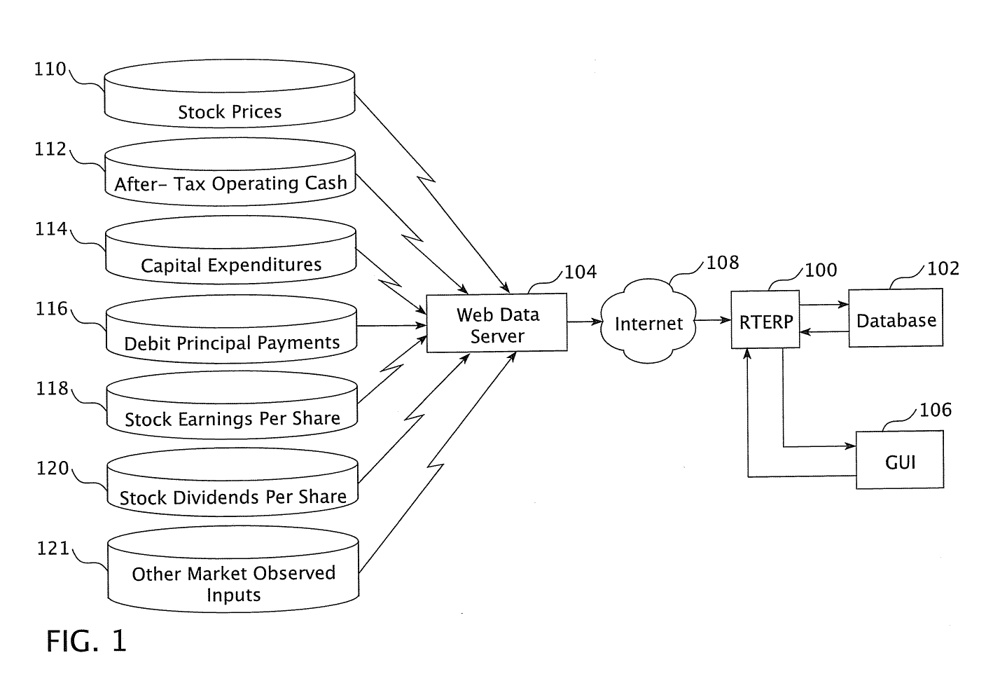

The real-time equity risk premium (“RTERP”) is a process and system that estimates the ex-ante ERP either in real time or as of a historical date that is specified by the user. As shown in FIG. 1, the RTERP is an integrated, software-based process and system wherein a computer 100 and a related database 102 process selected market data from third-party data services 104 and uses that data, according to the method herein disclosed, to determine the ex-ante ERP estimate.

The RTERP also includes a process and system that estimates ex-ante size, industry, and country risk premiums, along with descriptive statistics, graphs and charts. The integrated database 102 stores output from computer 100 as of the end of each trading day. That stored data makes historical RTERP estimates available without rerunning the entire RTERP process. The RTERP can have a graphical user interface 106 and may be made available through the Internet 108, intranet, third-party database queries (e.g., an application programming interface), or a prepackaged software application.

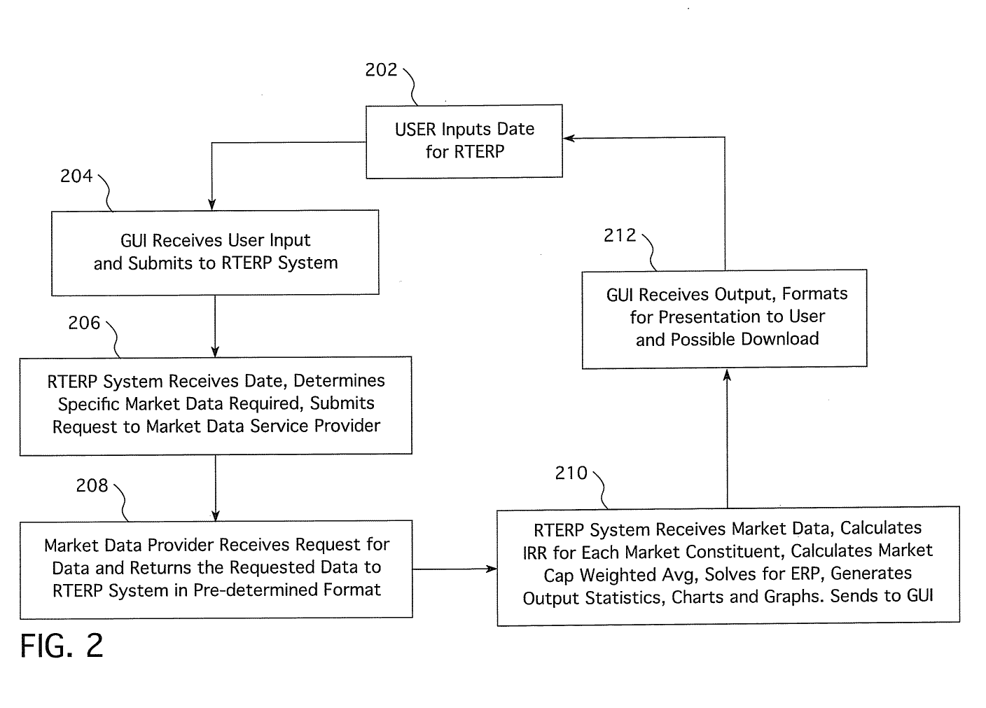

A presently disclosed embodiment of a system for implementing the RTERP process is shown and described in connection with FIGS. 1 and 2. FIG. 1 illustrates a presently disclosed embodiment of a system for implementing the RTERP process. FIG. 2 illustrates data flow in the system of FIG. 1. In the example of FIGS. 1 and 2, the disclosed system is specifically directed to determining the ex-ante ERP of publicly traded stocks. However, the scope of the presently enclosed invention is not specifically limited thereto and those skilled in the art will understand that the invention can be otherwise applied to other ex-ante risk premium estimates including, but not limited to, size premiums, industry premiums, and country premiums.

FIGS. 1 and 2 are schematic diagrams that illustrate a general hardware configuration and the data flow in the RTERP system. In the example of the preferred embodiment, a relational database management system 102 is combined with a computer 100. Computer 100 includes an internet information services server that provides Web application infrastructure. For example, the relational database management system can be a SQL server which is commercially available from Microsoft Corporation and the internet information services server can be a Microsoft IIS which is also commercially available from Microsoft Corporation.

A computer program stored on computer 100 has a plurality of code sections that are executable by computer 100 to cause the computer to populate a plurality of data fields in a memory with data concerning stock prices, after-tax operating cash flow, capital expenditures, debt principal payments, stock earnings per share, stock dividends per share and other information in accordance with the disclosed invention and as will be apparent from the disclosed embodiments. The program is developed in accordance with commercially available software tools that are known and used by those skilled in the art. For example, such software can be Visual Studio 2005 utilizing a managed code programming model such as .Net 2.0 Framework for building Web applications and database applications. Such software is commercially available from Microsoft Corporation.

In the embodiment of FIG. 1, the data that populates the information data fields in computer 100 is obtained from established sources that support web-data server 104. Server 104 cooperates with a plurality of data sources 110, 112, 114, 116, 118, and 120 to provide data concerning stock prices, after-tax operating cash flow, capital expenditures, debt principal payments, stock earnings per share, and stock dividends per share to server 104. More particularly, the data supports the RTERP process as hereinafter more fully explained. Data can be updated to computer 100 on a real-time basis or according to a time schedule. Such data also can be monitored and recorded over time so that a history of such data is developed.

As illustrated at 121 of FIG. 1, market observed inputs are not limited to those identified at 110, 112, 114, 116, 118 and 120 of FIG. 1. Established sources can also provide other market inputs as may be effective or useful in accordance with the presently disclosed invention such as, by example and without limitation, in recursively improving the accuracy of equity risk premium estimates, size risk premium estimates, industry risk premium estimates, and country risk premium estimates as hereinafter more fully explained.

In the system of FIG. 1, data is encrypted and sent from web server 104 to computer 100 through an internet link 108. The encryption and secure internet transmission by the system servers 104 and computer 100 and internet link 108 employ commercially available hardware according to methods that are known to those skilled in the art.

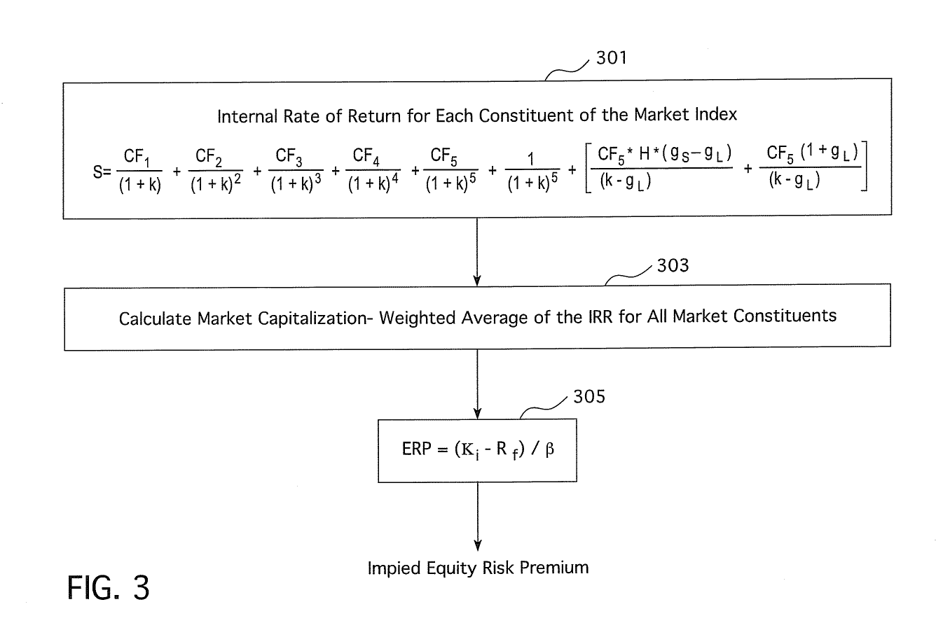

FIG. 2 further illustrates data flow of the system of FIG. 1 wherein at step 202 the user inputs the relevant date for the equity risk premium at 202 as key stroke commands to the graphical user interface 106. At step 204, the graphical user interface (“GUI”) receives the user input commands and submits that data to the RTERP computer 100. At 206, the RTERP computer 100 receives the relevant date and determines the specific market data that is required for an estimate of the equity risk premium on that date. Computer 100 then submits a request through Internet link 108 to server 104 of the market data service provider for that data. At step 208, the market data server 104 receives the data request, obtains the market data from sources 110-120, and returns the requested data to the RTERP computer 100 is a pre-determined format. As hereinafter more fully explained in relation to FIG. 3, at step 210, the RTERP computer receives the market data, calculates the internal rate of return (“IRR”) for each market component, calculates a market cap weighted average, solves for the equity risk premium, and generates output statistics, charts and graphs that are sent to GUI 106. At step 212, GUI 106 receives the output from computer 100 and formats the data for presentation to the user and possible download.

As more specifically illustrated in FIG. 3, the RTERP systems follows a bottom-up procedure for determining an ex-ante ERP, as follows:

At step 301, the system determines the long-term expected rate of return for each constituent of a market index such as the S&P 500. This calculation is based on the internal rate of return (IRR) required to reconcile each constituent's stock price with the present value of future cash flows that are based on consensus analyst estimates.

At step 303, the system estimates the long-term expected rate of return for the market index by calculating a market capitalization-weighted average of the IRRs identified in step 1 above. The expected rate of return on the index represents the implied cost of equity capital for the index.

At step 305, the system applies the capital asset pricing model (“CAPM”) framework to solve for the implied ERP. The risk-free rate is subtracted from the index-level cost of equity to estimate the ERP.

The RTERP process is agnostic with regard to the sources of market data. Bloomberg, Morningstar, Thomson Financial Network, Reuters, Edgar Online, Capital IQ, Standard & Poor's, Compustat, and other sources all may offer generally reliable data.

### IRR for Index Constituents

The RTERP process and system employ a bottom-up process. That is, they calculate an implied cost of equity for each index constituent. The implied cost of equity for each index constituent is determined by solving for the discount rate (in this case, the IRR) for which the present value of future cash flows equals the company's stock price. Assuming that consensus analyst estimates represent the general expectations of the market, the resulting discount rate represents the implied cost of equity.

### Cash Flows

The economic returns to equity holders can be measured by free cash flow to equity (FCFE), defined as after-tax operating cash flow less capital expenditures and debt principal payments. FCFE is available to return value to equity holders in the form of dividends, share buybacks, growth through acquisitions, and risk reduction by means of holding additional cash reserves.

The RTERP method and system use FCFE forecasts as a primary measure of expected future returns. The data necessary to calculate FCFE forecasts can be taken from a third-party database of consensus analyst estimates (e.g., Thomson Reuters, Capital IQ). The forecasted components of FCFE are available for the majority of index constituents. The RTERP uses earnings per share (EPS) as an additional expected future returns proxy. The RTERP uses dividends per share (DPS) estimates as a third proxy for investors' expected future returns (i.e. future cash flow). FCFE, EPS and DPS are referred to collectively as cash flow measures.

The cash flow measures are stated on a per-share basis for purposes of reconciling with stock prices in IRR calculations.

### Stock Prices

The stock price of each index constituent, as of the date of the ERP estimate, is taken from a data source.

### IRR Calculations

IRR calculations are performed in the context of a discounted future cash flow (DCF) analysis. The RTERP uses a three-stage DCF model.

First stage—Discrete period forecasts of cash flow are assumed to be a reliable approximation of expected rates of return over finite but sufficiently long periods such as five years or more. Discrete period forecasts of cash flow measures are based on consensus analyst estimates as of the date of the ERP estimate. The forecast horizon is five years. For companies without five years of analyst estimates available, the RTERP estimates the remaining discrete periods based on each company's growth rate in the latest forecasted period available.

Second stage—For RTERP modeling purposes, the smoothing period represents the second stage, in which growth transitions in a linear manner from the discretely forecasted periods to the stable growth rate used in the terminal period. The preferred embodiment assumes a two-year smoothing period. A smooth transition toward a long-term growth rate is believed to be a more realistic assumption than a sudden change found in two-stage models. An H-model is used to implement the smoothing period during the sixth and seventh years.

Third stage—This stage represents the terminal value (i.e., the present value of cash flows from the eighth year into perpetuity). Cash flows are capitalized using a Gordon growth model with a terminal growth rate. Common sources for the terminal growth include, but are not limited to, long-term inflation forecasts by the Federal Reserve Livingston Survey, long-term GDP growth forecasts by the Federal Reserve Livingston Survey, and yields on long-term U.S. Government bonds as well as other measures. In the specific example of the preferred embodiment, the yield on 20-year U.S. Government bonds as of the date of the risk premium estimate may be used as the risk-free rate.

As shown at 301 of FIG. 3, the three-stage discrete period forecast of cash flow model for calculating the IRR is expressed as follows:

$$S = \frac{{CF}_{1}}{( 1 + k )} + \frac{{CF}_{2}}{{( 1 + k )}^{2}} + \frac{{CF}_{3}}{{( 1 + k )}^{3}} \frac{{CF}_{4}}{{( 1 + k )}^{4}} + \frac{{CF}_{5}}{{( 1 + k )}^{5}} + \frac{1}{{( 1 + k )}^{5}} + [ \frac{{CF}_{5} * H * ( {g}_{S} - {g}_{L} )}{( k - {g}_{L} )} + \frac{{CF}_{5} ( 1 + {g}_{L} )}{( k - {g}_{L} )} ]$$

in which
S=Stock price at the date of the risk premium estimate
CFₜ=Forecasted cash flow measure for year t
g_{S}=Short-term growth rate during the smoothing period of the H-model

$${g}_{S} = \frac{{CF}_{5}}{{CF}_{4}} - 1$$

g_{L}=Long-term projected growth rate into perpetuity
H=Half-life of the smoothing period stated in years (i.e., for a two-year smoothing period, H=1)
k=IRR, also the cost-of-equity component

The observed market inputs are applied in an IRR calculation using the above framework to solve for k, which represents the implied cost of equity for the subject stock. The calculation is performed for each constituent of the market index.

### Market Capitalization and the Weighted Average

As shown at step 303 of FIG. 3, after the implied cost of equity is calculated for all market index constituents, the index-level cost of equity is calculated based on the market capitalization-weighted average cost of equity. Each index constituent's market capitalization is taken from a data source and used to weight the respective costs of equity in calculating the weighted average. That weighted average represents the implied expected return of the index.

### ERP Estimates and the CAPM Framework

The CAPM framework provides an analytical basis for determining the ERP from the index-level rate of return implied by observable market data.

The index's IRR is then applied to the CAPM in the following manner:

Kᵢ=R_{f}+β*(ERP)

Kᵢ=Cost of equity capital (i.e. the index-level expected rate of return)
R_{f}=The risk-free rate, assumed to equal the yield on 20-year U.S. governmental bonds as of the date of the risk premium estimate.
β—Market beta defined as 1 because the index is considered to be the market
ERP—Equity risk premium

Given that beta is equal to 1 for the index, the CAPM formula is simplified to the following:

Kᵢ=R_{f}+ERP

As illustrated at step 305, the RTERP model solves for the ex-ante ERP by deducting the risk-free rate from Kᵢ:

ERP=Kᵢ−R_{f}.

### Size Premium Estimates

Due to the excess historical returns of small stocks relative to the returns calculated using the CAPM, data sources that provide size premiums are often used. Such historical measures have most of the same weaknesses as ex-post ERP estimates described previously.

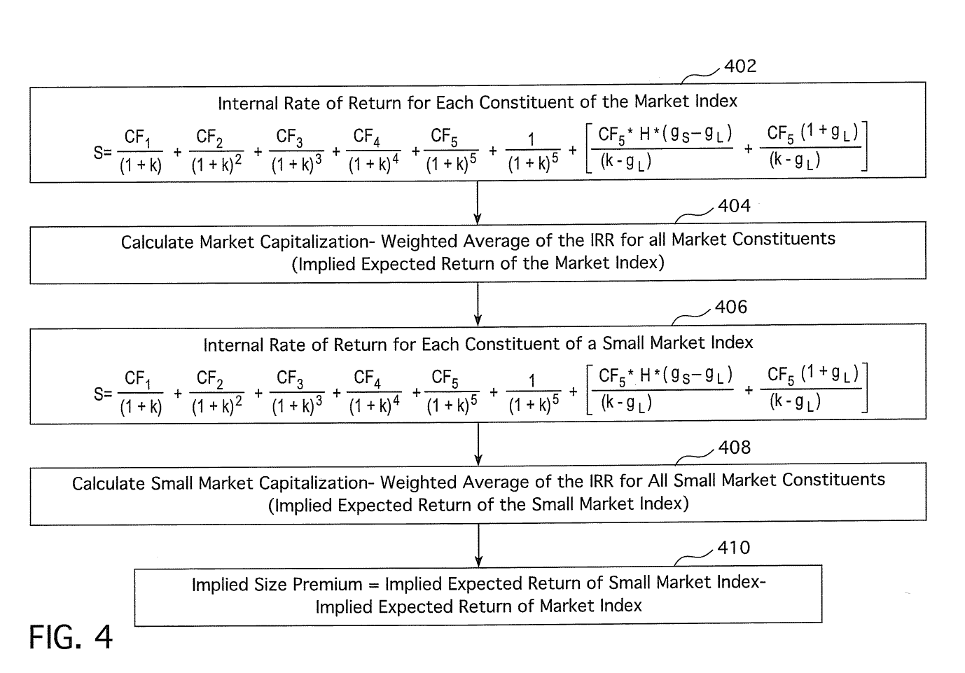

As illustrated in FIG. 4, ex-ante size premium estimates can be determined in much the same way as ex-ante ERP estimates. The RTERP determines ex-ante size premiums in the following way:

1. At steps 402 and 404 computer 100 computes the long-term expected rate of return for the market index based on the market capitalization-weighted average IRR for index constituents (following steps 301 and 303 referred to above).

2. At steps 406 and 408, computer 100 determines the long-term expected rate of return for a small company group by using the IRR calculation for each constituent of the small company group and then determining the weighted average for the small company group. The constituents of the small company group are not required to be constituents of the index. Size can be measured by several characteristics: market compilation, enterprises value, total assets, book value, revenue, various earnings measures and financial ratios, and other indicators.

3. At step 410, computer 100 calculates the implied size premium as the excess of the expected return for the small company group relative to the index.

### Industry Risk Premium Estimates

Currently, practitioners use data sources that provide Industry risk premiums based on the historical returns. Again, however, these measures have most of the weaknesses of ex-post ERP estimates previously discussed herein.

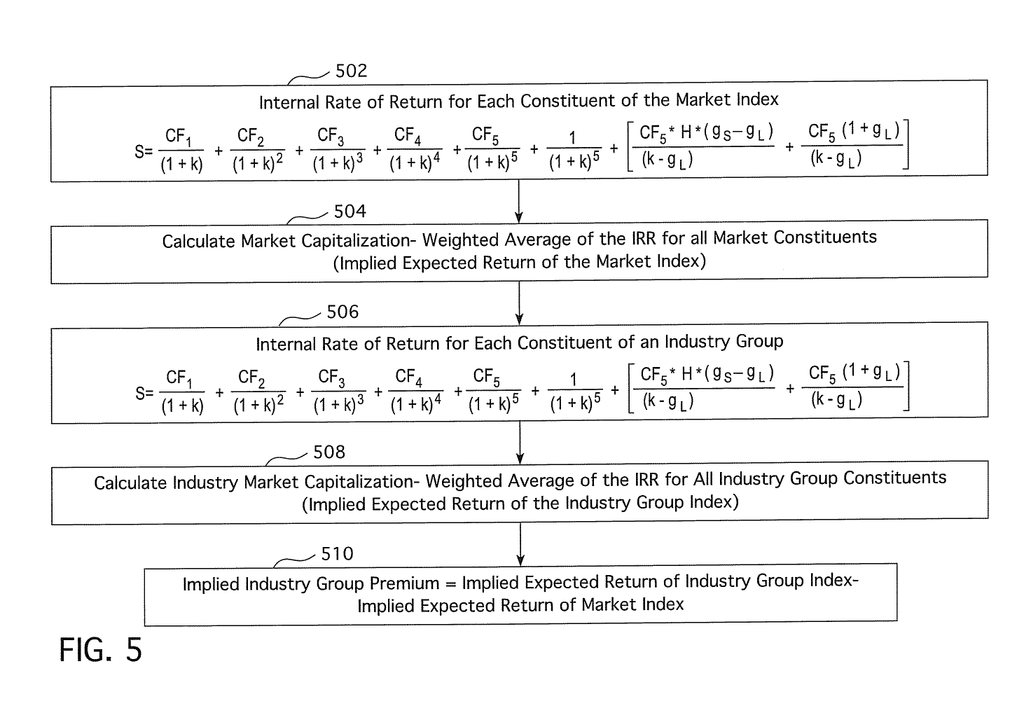

As illustrated in FIG. 5, ex-ante industry risk premium estimates can be determined in much the same way as an ex-ante size premium estimate. The RTERP determines ex-ante industry risk premiums according to the following steps:

1. At steps 502 and 504 computer 100 determines the long-term expected rate of return for the market index based on the market capitalization-weighted average IRR for the index constituents (following steps 301 and 303 described above).

2. At steps 506 and 508, computer 100 determines the long-term expected rate of return for an industry group by using the IRR calculation for each constituent of the industry group and then determining the weighted average for the industry group. The constituents of the industry group are not required to be constituents of the index.

3. At step 510, computer 100 calculates the implied industry premium as the excess of the expected return for the industry group relative to the index.

### Country Risk Premium Estimates

Due to the difference in historical returns of foreign equity investments relative to the returns of domestic investments, data sources that provide country risk premiums are often used. Such measures have most of the same weaknesses as ex-post ERP estimates described previously herein.

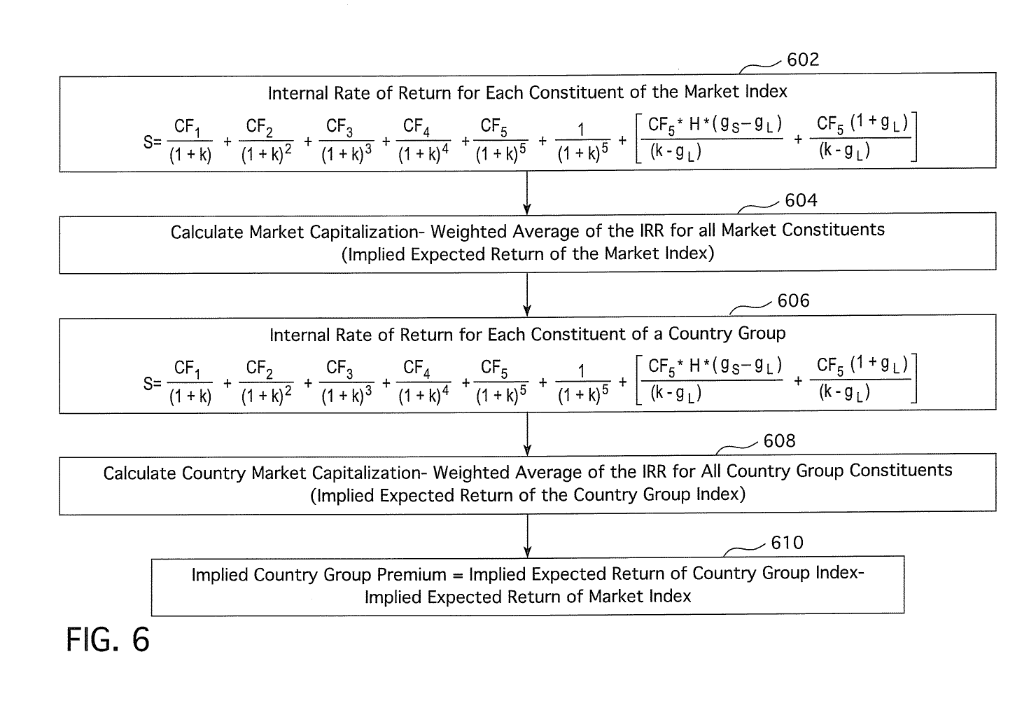

As illustrated in FIG. 6, ex-ante country risk premium estimates can be determined in much the same way as an ex-ante ERP estimates. The RTERP determines ex-ante country risk premiums according to the following steps:

1. At steps 602 and 604 computer 100 determines the long-teiiu expected rate of return for the domestic market index based on the market capitalization-weighted average IRR for the index constituents (following steps 301 and 303 described above).

2. At steps 606 and 608, computer 100 determines the long-term expected rate of return for a foreign market index by using the IRR calculation for each constituent of the foreign market index and then determining the weighted average for the foreign market index.

3. At step 610, computer 100 calculates the implied country risk premium as the excess of the expected return for the foreign market index relative to the domestic market index.

### Recursive Processing

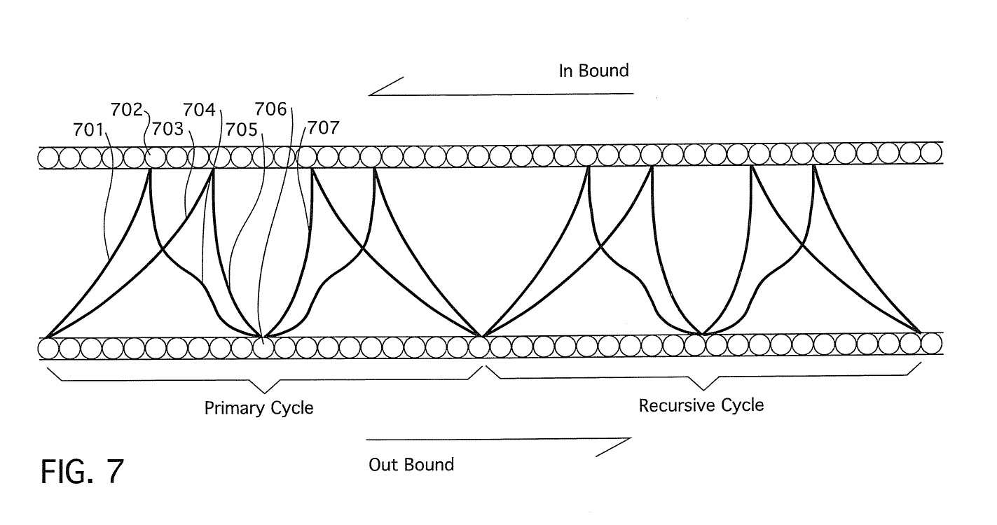

As illustrated in FIG. 7, RTERP estimates for ERP, industry risk, size risk, and country risk premium can be further improved by use of an informational feedback loop and recursively processing deviations of RTERP estimates from actual values for ERP, industry risk, size risk, and country risk premiums.

RTERP estimates of ERP, size risk premiums, industry risk premiums, and country risk premiums as determined according to the steps previously described are illustrated at 701. The RTERP estimates are recorded as illustrated by data node 702. Thereafter, the actual risk premium for the same time as empirically determined from actual market pricing is compared to the recorded RTERP values to determine a deviation in the RTERP estimate as illustrated at 703.

Deviations of the actual values from the RTERP estimates are analyzed to improve the predictive accuracy of the RTERP estimates. Typical methods of such analysis are known and understood by those skilled in the art and include methods such as statistical correlations (such as linear and multi-variate regression), principle component analysis, caconical variates analysis, or non-linear methods of data analysis such as neural networks.

The first step in such a process, illustrated at 704 is sometimes referred to as decomposition of a variance. Essentially, each variable to the risk premium estimate is analyzed in isolation (i.e. holding all other variables constant) to determine the variance necessary to match the empirically determined equity risk premium. In this way, the difference between the RTERP estimated risk premium and the actual risk premium is assessed over a dynamic range of a single variable. Examples of such variables include dividends, earnings, growth, time and the risk-free rate.

After each variable is analyzed in isolation as described, 705 illustrates that respective coefficients for the variables are associated with each of the independent variables to identify a “best fit” of the combination of variable coefficients for which the RTERP method most closely attains the actual equity risk premium. That is, the significance of the variables in the RTERP method is recalibrated to cause the estimated equity risk premium to most closely approximate the actual equity risk premium.

At 706, using the recalibrated or “best fit” variable coefficients, the RTERP process is re-run with new variable values to produce a new estimated equity risk premium. At 707, the estimated ERP is then compared to the actual ERP that corresponds to the same time as the new data set to identify the variance between the actual ERP and the ERP that is estimated using the “recalibrated” variable factors.

Thereafter, the forgoing process for “recalibrating” the variables of the RTERP is repeated in an iterative manner so that variance between the RTEP estimate of the ERP and the actual ERP is identified, the variables used in the RTERP process to find the estimated ERP are independently analyzed, the coefficients for each of the variables recalibrated to “best fit” the new actual ERP, and a new data set is applied to the process with newly revised coefficients to produce a refined RTERP estimated ERP. The actual ERP for the same time is thereafter compared to the estimated ERP and the cycle of identifying an ERP variance and recalibrating the RTERP variables to cause the estimated ERP to match the actual ERP is repeated. Over many repeated cycles, the accuracy and the reliability of the estimated ERP for predicting the actual ERP will increase.

The subject invention is not limited to synthesis of improved ERP estimates by coefficient adjustments to the variables that are used directly in the RTERP process. Other factors that influence the RTERP estimates only indirectly also can be integrated into the RTERP process. For example, the manner in which analysts are compensated may affect their market forecasts so as to bias their forecasts. The RTERP process does not directly account for analyst compensation plans. However, such indirect factors can be superimposed on the RTERP analysis, even though they are outside the RTERP process and are only indirectly related to the estimated ERP. By testing the analytical results over a sufficiently broad range of actual independent circumstances and through a sufficiently large number of recalibration iterations, the RTERP variables can be recalibrated to account for such independent factors as well. In this way, the RTERP process captures multiple market dynamics so that it more accurately and more completely accounts for historical, current and future circumstances in estimating the ERP for a given point in time.

### CONCLUSION

Accurate estimates of expected equity returns are important because they have far-reaching economic and financial implications for corporations, governments and individuals across all sectors of the global economy. Expected returns affect critical decisions such as allocating capital resources, pricing assets, and deteunining reserves for future obligations.

The RTERP is an innovative process that uses software and database programming, combined with economic and financial modeling, to provide estimates of the ex-ante ERP and size and industry risk premiums, along with relevant graphs and statistics. The RTERP represents the only available source for ex-ante risk premiums in real time or as of a historical date specified by the user. The RTERP has a graphical user interface and may be made available through the Internet, intranets, third-party database queries (via an application programming interface), or prepackaged software applications.

In summary, the RTERP provides more accurate ERP estimates than were previously available. As a result, investors, academics, practitioners and governments may be able to improve their ability to estimate key inputs affecting important decisions.

While several presently preferred embodiments of the invention have been shown and described herein, the presently disclosed invention is not limited thereto but can be otherwise variously embodied within the scope of the following claims.

We claim:

1. A method for estimating equity risk premium of a security that includes:
a. determining a long-term expected rate of return for each constituent of a market index from a discount rate that equates the present value of future cash flow with the constituent's stock price;
b. calculating a market capitalization-weighted average of the discount rates of the constituents of the market index;
c. determining an implied equity risk premium by subtracting the risk-free rate from the index cost of equity and adjusting for the market beta.

2. A method for determining equity risk premium, said method including the steps of:
a. determining a long-term expected rate of return for each constituent of a market index by determining, for each constituent, the internal rate of return for which the present value of future cash flow equates with the constituent's stock price;
b. calculating a market capitalization-weighted average of the internal rates of return of the constituents of the market index;
c. determining an implied equity risk premium by subtracting the risk-free rate from the market capitalization-weighted average of the internal rates of return and adjusting the difference for the market beta.

3. The method of claim 2 wherein capital expenditures and debt principal payments are subtracted from analysts estimates of future after-tax operating cash flow to determine free cash flow to equity.

4. The method of claim 2 wherein cash flows are determined from analysts estimates of free cash flow to equity.

5. The method of claim 2 wherein cash flows are equated to future earnings per share estimates of stock analysts.

6. The method of claim 2 wherein cash flows are equated to future dividends per share estimates of stock analysts.

7. The method of claim 2 wherein the step of calculating the cost of equity comprises the steps of:
a. Determining analyst estimates of future cash flow for a given time period;
b. Establishing a long-term growth rate; and
c. Developing a linear transition between the analyst estimates for future cash flow and the long-term growth rate.

8. The method of claim 7 wherein said step of determining analyst estimates comprises estimating discrete periods based on the company's growth rate in the most recent period for which analysts forecasts exist.

9. The method of claim 7 wherein said time period is five years.
The method of claim 7 wherein said step of determining analyst estimates is determined according to the relationship:
$$S = \frac{{CF}_{1}}{( 1 + k )} + \frac{{CF}_{2}}{{( 1 + k )}^{2}} + \frac{{CF}_{3}}{{( 1 + k )}^{3}} \frac{{CF}_{4}}{{( 1 + k )}^{4}} + \frac{{CF}_{5}}{{( 1 + k )}^{5}} + \frac{1}{{( 1 + k )}^{5}}$$
In which S=Stock price at the date of the risk premium estimate
CFt=Forecasted cash flow measure for year t; and
k=IRR, also the cost-of-equity component

10. The method of claim 7 wherein said step of developing a linear transition covers a two-year period.

11. The method of claim 7 wherein said step of developing a linear transition is determined according to the relationship:
$$[ \frac{{CF}_{5} * H * ( {g}_{S} - {g}_{L} )}{( k - {g}_{L} )} ]$$
In which S=Stock price at the date of the risk premium estimate
CFt=Forecasted cash flow measure for year t
gS=Short-term growth rate during the smoothing period of the H-model
$${g}_{S} = \frac{{CF}_{5}}{{CF}_{4}} - 1$$
gL=Long-term projected growth rate into perpetuity
H=Half-life of the smoothing period stated in years (i.e., for a two-year smoothing period, H=1)
k=IRR, also the cost-of-equity component

12. The method of claim 7 wherein said long-term growth rate is established for a period beginning after seven years.

13. The method of claim 7 wherein said long-term growth rate is determined according to the relationship:
$$[ \frac{{CF}_{5} ( 1 + {g}_{L} )}{( k - {g}_{L} )} ]$$
In which S=Stock price at the date of the risk premium estimate
CFt=Forecasted cash flow measure for year t
gL=Long-term projected growth rate into perpetuity
k=IRR, also the cost-of-equity component

14. The method of claim 1 wherein said step of calculating a market capitalization-weighted average of the discount rates of the constituents of the market index comprises:
a. For each constituent of the index, weighting the constituent's implied cost of equity according to that constituent's total market capitalization to determine a weighted average of all the constituents.

15. The method of claim 1 wherein the equity risk premium times the market beta is equated to the index-level expected rate of return minus the risk-free rate.

16. The method of claim 15 wherein the market beta is assumed to be unity.

17. The method of claim 16 wherein the risk-free rate of return is assumed to equate to the yield on 20-year U.S. government bonds as of the date of the risk premium estimate.

18. A method for estimating equity risk premium of a security that includes:
a. Determining a long-term expected rate of return for each constituent of a market index by determining a discount rate that equates the present value of future cash flow with the constituent's stock price;
b. Calculating a market capitalization-weighted average of the discount rates of the constituents of the market index;
c. Determining an implied equity risk premium from the CAPM; and
d. Subtracting the risk-free rate from the index cost of equity.

19. A method for determining a size premium for an equity comprising the steps of:
a. determining a long-term expected rate of return for each constituent of a market index by determining a discount rate that equates the present value of future cash flow with the constituent's stock price;
b. calculating a market capitalization-weighted average of the discount rates of the constituents of the market index;
c. determining a long-term expected rate of return for each constituent of a small capitalization group by determining the discount rate that equates the present value of future cash flow with the stock price of the constituent of the small capitalization group;
d. calculating a market capitalization-weighted average of the discount rates of the constituents of the small capitalization group; and
e. computing the size premium as the excess of the expected return for the small company group relative to the return for the index.

20. A method for determining an industry risk premium for an equity comprising the steps of:
a. determining a long-term expected rate of return for each constituent of a market index by determining a discount rate that equates the present value of future cash flow with the constituent's stock price;
b. calculating a market capitalization-weighted average of the discount rates of the constituents of the market index;
c. determining a long-term expected rate of return for each constituent of an industry group by determining the discount rate that equates the present value of future cash flow with the stock price of the constituent of the industry group;
d. calculating a market capitalization-weighted average of the discount rates of the constituents of the industry group; and
e. computing the industry premium as the excess of the expected return for the industry group relative to the return for the index.

21. A method for adjusting an equity risk premium, said method comprising the steps of:
a. estimating an equity risk premium as of a given future time;
b. assessing the equity risk premium that is thereafter actually attained;
c. sensing decomposition between the estimated equity risk premium and the actual equity risk premium;
d. estimating the variance between the estimated equity risk premium and the actual equity risk premium;
e. assessing the estimated variance relative to the sensed decomposition; and
f. revising the estimate of the equity risk premium to account for the estimated variance.

22. A machine readable storage having stored thereon a computer program for determining the risk premium of a security, said program having a plurality of code sections that are executable by a machine for causing the machine to perform the steps of:
a. determining a long-term expected rate of return for each constituent of a market index from a discount rate that equates the present value of future cash flow with the constituent's stock price;
b. calculating a market capitalization-weighted average of the discount rates of the constituents of the market index; and
c. determining an implied equity risk premium by subtracting the risk-free rate from the index cost of equity and adjusting for the market beta.

23. The machine-readable storage of claim 22 wherein said program causes the machine to:
a. determine a long-term expected rate of return for each constituent of a market index by determining, for each constituent, the internal rate of return for which the present value of future cash flow equates with the constituent's stock price;
b. calculate a market capitalization-weighted average of the internal rates of return of the constituents of the market index; and
c. determine an implied equity risk premium by subtracting the risk-free rate from the market capitalization-weighted average of the internal rates of return and adjusting the difference for the market beta.

24. The machine-readable storage of claim 23 wherein capital expenditures and debt principal payments are subtracted from analysts estimates of future after-tax operating cash flow to determine free cash flow to equity.

25. The machine-readable storage of claim 23 wherein cash flows are determined from analysts estimates of free cash flow to equity.

26. The machine-readable storage of claim 23 wherein cash flows are equated to future earnings per share estimates of stock analysts.

27. The machine-readable storage of claim 23 wherein cash flows are equated to future dividends per share estimates of stock analysts.

28. The machine-readable storage of claim 23 wherein the machine calculates the cost of equity by:
a. Determining analyst estimates of future cash flow for a given time period;
b. Establishing a long-term growth rate; and
c. Developing a linear transition between the analyst estimates for future cash flow and the long-term growth rate.

29. The machine-readable storage of claim 28 wherein the machine determines analyst estimates by estimating discrete periods based on the company's growth rate in the most recent period for which analyst forecasts exist.

30. The machine-readable storage of claim 28 wherein said time period is five years.

31. The machine-readable storage of claim 28 wherein the machine determines analyst estimates according to the relationship:
$$S = \frac{{CF}_{1}}{( 1 + k )} + \frac{{CF}_{2}}{{( 1 + k )}^{2}} + \frac{{CF}_{3}}{{( 1 + k )}^{3}} \frac{{CF}_{4}}{{( 1 + k )}^{4}} + \frac{{CF}_{5}}{{( 1 + k )}^{5}} + \frac{1}{{( 1 + k )}^{5}}$$
In which S=Stock price at the date of the risk premium estimate
CFt=Forecasted cash flow measure for year t; and
k=IRR, also the cost-of-equity component

32. The machine-readable storage of claim 28 wherein the machine develops a linear transition for a two-year period.

33. The machine-readable storage of claim 28 wherein the machine develops a linear transition according to the relationship:
$$[ \frac{{CF}_{5} * H * ( {g}_{S} - {g}_{L} )}{( k - {g}_{L} )} ]$$
In which S=Stock price at the date of the risk premium estimate
CFt=Forecasted cash flow measure for year t
gS=Short-turn growth rate during the smoothing period of the H-model
$${g}_{S} = \frac{{CF}_{5}}{{CF}_{4}} - 1$$
gL=Long-term projected growth rate into perpetuity
H=Half-life of the smoothing period stated in years (i.e., for a two-year smoothing period, H=1)
k=IRR, also the cost-of-equity component

34. The machine-readable storage of claim 28 wherein the machine establishes said long-term growth rate for a period beginning after seven years.

35. The machine-readable storage of claim 28 wherein the machine determines said long-term growth rate according to the relationship:
$$[ \frac{{CF}_{5} ( 1 + {g}_{L} )}{( k - {g}_{L} )} ]$$
In which S=Stock price at the date of the risk premium estimate
CFt=Forecasted cash flow measure for year t
gL=Long-term projected growth rate into perpetuity
k=IRR, also the cost-of-equity component

36. The machine-readable storage of claim 22 wherein said machine calculates a market capitalization-weighted average of the discount rates of the constituents of the market index for each constituent of the index by weighting the constituent's implied cost of equity according to that constituent's total market capitalization to determine a weighted average of all the constituents.

37. The machine-readable storage of claim 22 wherein the machine equates the product of the equity risk premium times the market beta to the index-level expected rate of return minus the risk-free rate.

38. The machine-readable storage of claim 37 wherein the machine equates the market beta to unity.

39. The machine-readable storage of claim 38 wherein the machine equates the risk-free rate of return to the yield on 20-year U.S. government bonds as of the date of the risk premium estimate.

40. The machine-readable storage of claim 23 wherein cash flows are equated to the cash flow estimates for underlying companies by stock analysts.

41. A machine readable storage having stored thereon a computer program for determining the risk premium of a security, said program having a plurality of code sections that are executable by a machine for causing the machine to perform the steps of:
a. determining a long-term expected rate of return for each constituent of a market index by determining a discount rate that equates the present value of future cash flow with the constituent's stock price;
b. calculating a market capitalization-weighted average of the discount rates of the constituents of the market index;
c. determining an implied equity risk premium from the CAPM; and
d. subtracting the risk-free rate from the index cost of equity.

42. A machine readable storage having stored thereon a computer program for determining the size risk premium of a security, said program having a plurality of code sections that are executable by a machine for causing the machine to perform the steps of:
a. determining a long-term expected rate of return for each constituent of a market index by determining a discount rate that equates the present value of future cash flow with the constituent's stock price;
b. calculating a market capitalization-weighted average of the discount rates of the constituents of the market index;
c. determining a long-term expected rate of return for each constituent of a small capitalization group by determining the discount rate that equates the present value of future cash flow with the stock price of the constituent of the small capitalization group;
d. calculating a market capitalization-weighted average of the discount rates of the constituents of the small capitalization group; and
e. computing the size premium as the excess of the expected return for the small company group relative to the return for the index.

43. A machine readable storage having stored thereon a computer program for determining the industry risk premium of a security, said program having a plurality of code sections that are executable by a machine for causing the machine to perform the steps of:
a. determining a long-term expected rate of return for each constituent of a market index by determining a discount rate that equates the present value of future cash flow with the constituent's stock price;
b. calculating a market capitalization-weighted average of the discount rates of the constituents of the market index;
c. determining a long-term expected rate of return for each constituent of an industry group by determining the discount rate that equates the present value of future cash flow with the stock price of the constituent of the industry group;
d. calculating a market capitalization-weighted average of the discount rates of the constituents of the industry group; and
e. computing the industry premium as the excess of the expected return for the industry group relative to the return for the index.

44. A machine readable storage having stored thereon a computer program for determining an equity risk premium of a security, said program having a plurality of code sections that are executable by a machine for causing the machine to perform the steps of:
a. estimating an equity risk premium as of a given future time;
b. assessing the equity risk premium that is thereafter actually attained;
c. sensing decomposition between the estimated equity risk premium and the actual equity risk premium;
d. estimating the variance between the estimated equity risk premium and the actual equity risk premium;
e. assessing the estimated variance relative to the sensed decomposition; and
f. revising the estimate of the equity risk premium to account for the estimated variance.

45. The method for estimating equity risk premium of claim 1 where said risk premium is estimated as of a given date and further comprising the steps of:
a. recording the estimated equity risk premium for a given data;
b. identifying the actual equity risk premium as of the same date;
c. comparing the estimated equity risk premium and the actual equity risk premium for a given data to determine a variance and decomposing the variance;
d. assessing the variance with respect to the decomposition; and
e. revising the estimate as of said given data.

46. A machine readable storage having stored thereon a computer program for determining the country risk premium of a security, said program having a plurality of code sections that are executable by a machine for causing the machine to perform the steps of:
a. determining a long-term expected rate of return for each constituent of a domestic market index by determining a discount rate that equates the present value of future cash flow with the constituent's stock price;
b. calculating a market capitalization-weighted average of the discount rates of the constituents of the domestic market index;
c. determining a long-term expected rate of return for each constituent of a foreign market index by determining the discount rate that equates the present value of future cash flow with the stock price of the constituent of the foreign market index;
d. calculating a market capitalization-weighted average of the discount rates of the constituents of the foreign market index; and
e. computing the country risk premium as the excess of the expected return for the foreign market index relative to the return for the domestic market index.
